(19) United States
(12) Patent Application Publication
(10) Pub. No.: US 2006/0025106 A1
(43) Pub. Date: Feb. 2, 2006

(54) Method for alerting wireless units of an impending emergency situation

(76) Inventors: Charles Calvin Byers, Wheaton, IL (US); James Philip Runyon, Wheaton, IL (US)

Correspondence Address: Lucent Technologies Inc.;Docket Administrator - Room 3J-219, 101 Crawfords Corner Road, Holmdel, NJ, 07733-3030, US

(21) Appl. No.: 10/901,683

(22) Filed: Jul. 29, 2004

(51) Int. Cl. H04Q 7/20

(52) U.S. Cl. 455/404.2; 455/456.1

(57) ABSTRACT

The present invention provides a method for alerting wireless units of an impending emergency situation. A wireless communication network or government authority forecasts the path of an impending emergency situation to create an impending impact area. The wireless communication network determines the wireless units that are located within the impending impact area. The wireless communication network alerts the wireless units that are located within the impending impact area of the impending emergency situation, providing multi-media instructions to the users of the wireless units.

### FIELD OF THE INVENTION

The present invention relates generally to wireless communication systems, and more particularly to a wireless communication system that alerts wireless units of impending emergencies.

### BACKGROUND OF THE INVENTION

Thousands of people are killed or injured every year by severe weather conditions or other disasters. Many of these tragedies could have been avoided if there were some way of alerting those people who are in the direct path of the most severe weather condition or disaster in time for them to take appropriate shelter or move out of the path of the disaster.

Many municipalities have early warning siren systems that provide general warnings, but unfortunately many people are unable to hear them, or don't realize the seriousness of a very general alarm until it is too late. Broadcast media are also a traditional means of distributing alerts of severe weather or other disasters, but people in the path of the weather aren't always tuned in to appropriate radio or television stations.

Therefore, a need exists for a method and apparatus that will provide high-resolution, specific, real-time alerts for approaching severe weather conditions or other disasters.

### BRIEF SUMMARY OF THE INVENTION

The present invention utilizes wireless units, such as cellular phones, PDAs, etc., to alert subscribers of impending emergencies such as severe weather or Weapons of Mass Destruction (WMD) incidents. The present invention uses a wireless communication network and forecasting and emergency response networks to inform subscribers in the direct path of an emergency event to take appropriate precautions. The wireless communication network uses the emerging geographic location services being added to mobile devices to aid E911 services as a means of locating the devices to be alerted.

In accordance with an exemplary embodiment of the present invention, the wireless communication network determines which wireless units are in the path of an impending emergency situation and sends a high priority alert to those devices, instructing the subscribers to take appropriate action. The wireless communication network uses geographic location information about all the mobile devices connected to the wireless communication network to inform only the users that are in an area affected by the emergency situation.

The present invention thereby provides a method for informing users in the direct path of the emergency to take action much faster and more accurately than any mass media or civil defense system can. In addition, users in the path of an impending emergency situation receive instructions specific to their particular situation, including the type of emergency situation, the direction that the emergency situation is moving, or other pertinent information, including multimedia information relating to the impending emergency situation. The instructions can be different depending upon the exact location of the emergency, and the users positional relation to it. For example, users located north of a toxic spill will be told to move north, while users south of it will be instructed to move south.

### BRIEF DESCRIPTION OF THE SEVERAL VIEWS OF THE DRAWINGS

FIG. 1 depicts a communication system in accordance with an exemplary embodiment of the present invention.

FIG. 2 depicts a cellular grid of a wireless communication system and including a depiction of an impending emergency situation in accordance with an exemplary embodiment of the present invention.

FIG. 3 depicts a flowchart of a method for alerting wireless units of an impending emergency situation in accordance with an exemplary embodiment of the present invention.

### DETAILED DESCRIPTION OF THE INVENTION

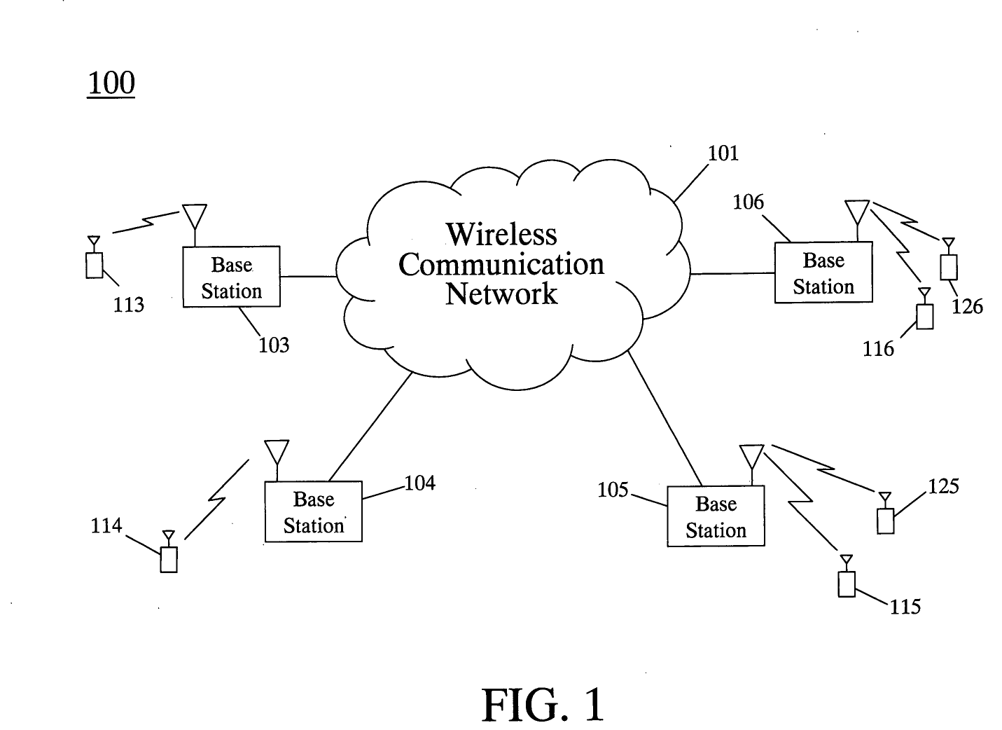

The present invention can be better understood with reference to FIGS. 1 through 3. FIG. 1 depicts a communication system 100 that includes a wireless communication network 101. Communication system 100 may include a wireline communication network, such as the Public Switched Telephone Network (PSTN) and a plurality of wireless networks, but only wireless communication network 101 is depicted in FIG. 1 for clarity.

Wireless communication network 101 includes at least one Mobile Switching Center (MSC), and each MSC is connected to a plurality of base stations. FIG. 1 depicts four base stations, base stations 103, 104, 105, and 106. Each base station communicates with wireless units located within its transmission area, commonly referred to as a cell.

As depicted in FIG. 1, base station 103 communicates with wireless unit 113, base station 104 communicates with wireless unit 114, base station 105 communicates with wireless units 115 and 125, and base station 106 communicates with wireless units 116 and 126. Wireless units include cell phones, Personal Digital Assistants (PDAs), wireless email terminals, etc.

Wireless communication network 101 can utilize any wireless protocol, including but not limited to analog, such as AMPS, TACS and NMT, or digital, such as GSM, TDMA, CDMA, GPRS, EDGE, IS-95, IS-95B, HDR, WCDMA, CDMA2000, or wireless LAN/MAN technologies such as Wi-Fi (Wireless-Fidelity), WiMax, and IEEE 802.11. Base stations 103, 104, 105, and 106 communicate with wireless communication network 101 via an MSC and communication over the air with wireless units. Base stations 103, 104, 105, and 106 can be communicating with the same MSC or with different MSCs. It should be understood that wireless communication network 101 typically includes a plurality of MSCs, each of which communicates with a plurality of base stations, and each base station services a plurality of wireless units.

An MSC processes call and service request initiated by one of the wireless units and allocates the required transmission and signaling resources.

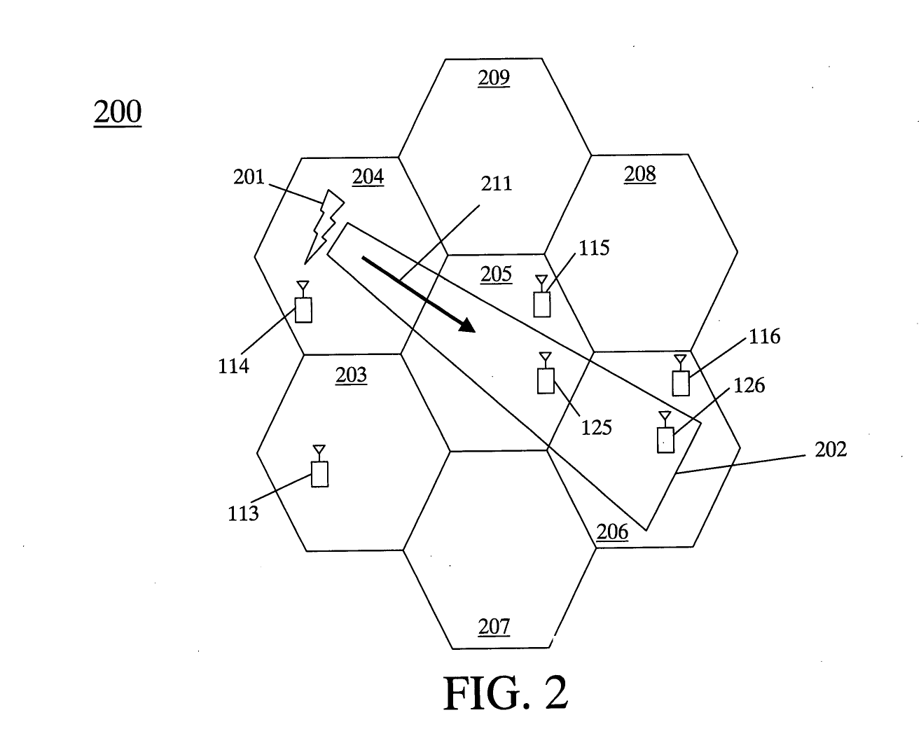

FIG. 2 depicts a cellular grid 200 of a wireless communication system and including a depiction of an impending emergency situation 201 in accordance with an exemplary embodiment of the present invention.

Cellular grid 200 comprises a plurality of overlapping cells 203 through 209. Cellular grid 200 preferably extends beyond the seven cells depicted in FIG. 2. Each cell includes a base station that communicates with wireless units located within the cell. Although base stations are not depicted in FIG. 2, each cell 203 through 209 includes one base station. Base station 103 is located in cell 203, base station 104 is located in cell 204, base station 105 is located in cell 205, and base station 106 is located in cell 206.

Impending emergency situation 201 is depicted in FIG. 2 as a lightning bolt. Impending emergency situation 201 can be any situation that could be dangerous to someone who comes in contact with it. Impending emergency situation 201 can be a weather condition, such as a thunderstorm, tornado, hurricane, or tsunami, or a geological condition, such as an earthquake or volcano. Impending emergency situation can alternately be a man-made disaster, such as a bomb, hazardous material leak or spill, biological threat, or nuclear radiation incident.

Impending emergency situation 201 can be moving or spreading. For example, if impending emergency situation 201 is a thunderstorm, hurricane, or tornado, it will most likely have a path of movement 211. Users who are in the path of impending emergency situation 201 would benefit by being alerted to the dangerous situation. This allows the users to move away from the path of impending emergency situation 201 or take appropriate cover from the dangerous situation.

The present invention forecasts the path of impending emergency situation 201 to create an impending impact area 202. Impending impact area 202 depicts the geographic area into which impending emergency situation 201 is expected to move. In an exemplary embodiment, impending impact area 202 is a polygonal-shaped geographic region and extends into multiple cells.

Wireless communication network determines the wireless units that are located within the impending impact area 202. In an exemplary embodiment, the wireless communication network utilizes GPS satellites or triangulation techniques to determine the wireless units in impending impact area 202.

A geographic database of the layout of wireless communication network 101, a second database showing the current location of the wireless units, and a third database showing impending impact area 202 are all consulted, and a determination of which wireless units should be notified is made. The wireless communication network then alerts the wireless units based upon proximity to the impending emergency situation.

As depicted in FIG. 2, wireless units 115 and 125 are located within cell 205. Wireless unit 125 is depicted as being within impending impact area 202, while wireless unit 115 is depicted as being outside of impending impact area 202. Utilizing the present invention, the level of granularity of the alerting can be modified. For example, in a first exemplary embodiment that utilizes less precise location determinations, all wireless units located within any cell into which impending impact area 202 extends would be alerted by the wireless communication network of impending emergency situation 201. In a second exemplary embodiment, utilizing location determination that is able to determine the location of a wireless unit to a higher level of specificity, wireless unit 125 would be alerted to impending emergency situation 201 and wireless unit 115 would not be alerted, since wireless unit 115 is located outside of impending impact area 202.

The present invention can also a set of moving wireless units that may enter the impending impact area. For example, wireless unit 116 is depicted as being outside of impending impact area 202. However, using location determination and movement processes, the wireless communication network may determine that wireless unit 116 is moving toward impending impact area 202. In this case, the wireless communication network can alert wireless unit 116 of impending emergency situation 201, thereby allowing the user of wireless unit 116 to take appropriate measures to stay clear of impending emergency situation 201.

Wireless communication network may prioritize the transmission of alert messages to wireless units. The wireless communication network may send message to wireless units based upon their proximity to impending emergency situation 201. Proximity is preferably determined by calculating the distance from each wireless unit to the current position of the center of the emergency situation, and sorting the units in ascending order of distance. In FIG. 2, wireless communication network would send the first alert message to wireless unit 125, and the second alert message to wireless unit 126. In this manner, wireless unit 125, which is disposed closest to impending emergency situation 201, will be given the first alert and will be able to take the first action to protect from impending emergency situation 201.

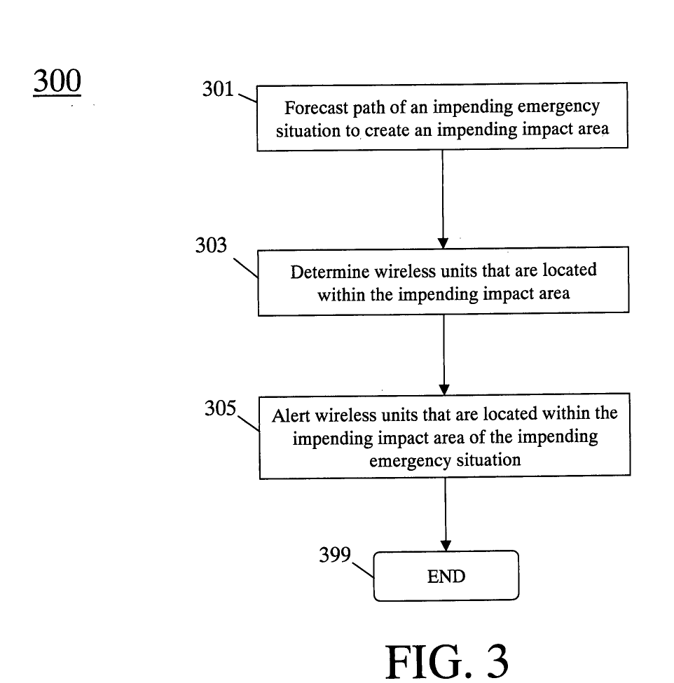

FIG. 3 depicts a flowchart 300 of a method for alerting wireless units of an impending emergency situation in accordance with an exemplary embodiment of the present invention.

The wireless communication network forecasts (301) the path of an impending emergency situation to create an impending impact area. In an exemplary embodiment, the wireless communication network determines the impending impact area by analyzing weather-prediction data or WMD hazard footprint and generating a polygonal-shaped geographic region. The polygonal-shaped region represents the area into which the impending emergency is predicted to move into. The wireless communication network or government authority can use velocity of the impending emergency situation, wind speed and direction, the spreading factor of impending emergency situation, and other factors to forecast the path of the impending emergency situation.

In an exemplary embodiment, the wireless communication network works with the geo-location features that allow the wireless communication network to determine the location of the wireless units and a weather forecasting system. When severe weather events threaten, the weather service uses their forecasting infrastructure to determine a polygonal-shaped geographic region in the likely path of the storm. The geometry of this region, along with the specific emergency and instructions for users in the region, would be forwarded to the wireless communication network.

The wireless communication network determines (303) the wireless units that are located within the impending impact area, preferably performed by communication network servers that consult location databases showing the position of the wireless units, and the layout of the wireless network. In an exemplary embodiment of the present invention, the step of determining the wireless units that are located within the impending impact area comprises utilizing GPS satellites. In a further exemplary embodiment, the location of wireless units is determined utilizing triangulation techniques. In a further exemplary embodiment, the step of determining the wireless units that are located within the impending impact area comprises determining the location of base stations transmitting to the wireless units that are located within the impending impact area. In this embodiment, any cells that will be touched by the impending impact area will transmit an alert to all wireless units located within the cell.

The wireless communication network alerts (305) the wireless units that are located within the impending impact area of the impending emergency situation. The wireless communication network sends an alert message to each of the wireless units that are located within the impending impact area. In an exemplary embodiment, the alert message includes an indication of the type of emergency. The alert message alternately includes multimedia information relating to the emergency, such as maps, pictures, video, instructions, or other information that would be helpful to a user of a wireless unit that is located in the impending impact area. The information can include the location of shelters from the impending emergency situation, and could also include a map of the impending impact area. In an exemplary embodiment, the instructions can be unique for each user, and can be based upon the location of the emergency and the user's positional relation to it. For example, users located north of a toxic spill can be told to move north, while users located south of the toxic spill can be instructed to move south.

The alert message preferably has a higher priority than a normal message and is sent based upon the proximity of a wireless unit to the impending emergency situation. In an exemplary embodiment, the wireless communication network sends a unique alert tone to the wireless units that are located within the impending impact area. This tone will alert a user of the wireless unit of the impending emergency, and overrides any settings on the wireless unit. For example, if the wireless unit is set to vibrate only mode, the unique alert tone will still be played on the wireless unit. Further, the tone is preferably played at the maximum volume, even if the wireless unit is set to mute or a volume level less than the maximum volume level.

While this invention has been described in terms of certain examples thereof, it is not intended that it be limited to the above description, but rather only to the extent set forth in the claims that follow.

We claim:

1. A method for alerting wireless units of an impending emergency situation, the method comprising:
forecasting the path of an impending emergency situation to create an impending impact area;
determining the wireless units that are located within the impending impact area; and
alerting the wireless units that are located within the impending impact area of the impending emergency situation.

2. A method for alerting wireless units of an impending emergency situation in accordance with claim 1, the method further comprising determining a set of moving wireless units that may enter the impending impact area.

3. A method for alerting wireless units of an impending emergency situation in accordance with claim 1, wherein the step of alerting the wireless units that are located within the impending impact area comprises sending an alert message to the wireless units that are located within the impending impact area, and wherein the alert message includes an indication of the type of emergency.

4. A method for alerting wireless units of an impending emergency situation in accordance with claim 1, wherein the step of alerting the wireless units that are located within the impending impact area comprises sending an alert message to the wireless units that are located within the impending impact area, and wherein the alert message includes multimedia information relating to the emergency.

5. A method for alerting wireless units of an impending emergency situation in accordance with claim 1, wherein the step of determining the wireless units that are located within the impending impact area comprises utilizing GPS satellites.

6. A method for alerting wireless units of an impending emergency situation in accordance with claim 1, wherein the step of determining the wireless units that are located within the impending impact area comprises utilizing triangulation techniques.

7. A method for alerting wireless units of an impending emergency situation in accordance with claim 1, wherein the step of determining the wireless units that are located within the impending impact area comprises determining the location of base stations transmitting to the wireless units that are located within the impending impact area.

8. A method for alerting wireless units of an impending emergency situation in accordance with claim 7, wherein the base stations are Wi-Fi base stations.

9. A method for alerting wireless units of an impending emergency situation in accordance with claim 7, wherein the base stations are WiMax base stations.

10. A method for alerting wireless units of an impending emergency situation in accordance with claim 7, wherein the base stations are microcell base stations.

11. A method for alerting wireless units of an impending emergency situation in accordance with claim 1, wherein the step of alerting the wireless units that are located within the impending impact area of the impending emergency situation comprises sending an alert message that has a higher priority than a normal message.

12. A method for alerting wireless units of an impending emergency situation in accordance with claim 1, wherein the step of alerting the wireless units that are located within the impending impact area of the impending emergency situation comprises sending a unique alert tone to the wireless units that are located within the impending impact area.

13. A method for alerting wireless units of an impending emergency situation in accordance with claim 12, wherein the unique alert tone sent to the wireless units that are located within the impending impact area overrides a wireless unit set to quiet mode.

14. A method for alerting wireless units of an impending emergency situation in accordance with claim 1, wherein the step of alerting the wireless units that are located within the impending impact area comprises sending an alert message to the wireless units that are located within the impending impact area, and wherein the alert message includes the impending impact area.

15. A method for alerting wireless units of an impending emergency situation in accordance with claim 1, wherein the step of alerting the wireless units that are located within the impending impact area comprises sending an alert message to the wireless units that are located within the impending impact area, and wherein the alert message includes instructions for users of the wireless units that are located within the impending impact area.

16. A method for alerting wireless units of an impending emergency situation in accordance with claim 1, wherein the step of forecasting the path of an impending emergency situation comprises generating a polygonal-shaped geographic region.

17. A method for alerting wireless units of an impending emergency situation in accordance with claim 1, wherein the step of determining the wireless units that are located within the impending impact area is performed by communication network servers that consult location databases.

18. A method for alerting wireless units of an impending emergency situation in accordance with claim 1, wherein the step of alerting the wireless units that are located within the impending impact area comprises alerting the wireless units based upon proximity to the impending emergency situation.

19. A method for alerting wireless units of an impending emergency situation in accordance with claim 1, wherein the step of alerting the wireless units that are located within the impending impact area comprises the steps of:
sending a first message to a first wireless unit located within the impending impact area; and
sending a second message that is different than the first message to a second wireless unit located within the impending impact area.
